(19) United States
(12) Patent Application Publication
(10) Pub. No.: US 2017/0122493 A1
(43) Pub. Date: May 4, 2017

(54) TRUSS STORAGE HANGING CROSSBAR BRACKETS

(71) Applicant: ERIC DAMMANN, VENICE, FL (US)

(72) Inventor: ERIC DAMMANN, VENICE, FL (US)

(21) Appl. No.: 15/287,642

(22) Filed: Oct. 6, 2016

Related U.S. Application Data
(60) Provisional application No. 62/237,854, filed on Oct. 6, 2015.

(51) Int. Cl. F16M 13/02

(52) U.S. Cl. CPC F16M 13/022

(57) ABSTRACT

Self supporting inverted U shaped brackets that freely hang on a truss or rafter beam allowing a round rod to slide through the hole creating a single crossbar support where as another set may be placed a chosen length away creating a two axle area for storing item across. Plywood laid across the pair of rods makes for an instant shelf as this creates a do it yourself overhead storage shelving system that mounts on truss or rafters normally found in a garage type structure which can be used commercially but designed for the homeowner as it is lightweight, sturdy and requires no tools or experience to erect. This is not a floor system but an adjustable removable shelf type system that uses no hardware and does not compromise the integrity of the wood and can be reached with just a stepladder depending on wall height.

The lack of storage for items (personal & professional) has always been a problem for most people. We never have enough space! Many homes have attics, complete with an unsteady pull down ladder and a small access hole to get through as one climbs up. Putting large items such as boxes, luggage, holiday decorations and seasonal items, such as sleds, skis, winter clothes, coolers, rafts etc., make it quite difficult and even dangerous, as you climb up with your arms full. Upon entering the attic, one usually finds little space (if any) in the center to pile things about, while trying not to step off a board and fall through the ceiling. So even with that being said, stuff still lays around in the garage and the family vehicle sits outside in the elements. Some people have the resources to build sheds, barns and detached garages, and they usually build those without ceiling board, and leave open air trusses. In order to get items out of their way, people will run nails and screws into the trusses to hang things like bikes, hoses, cords, shovels, rakes etc., while compromising the integrity of trusses with holes, cracks and splits which are also perfect for moisture and bug infestation. Truss Storage Hanging Crossbar Brackets help answer most of these problems and needs. Most any warehouse, barn, shed, garage (detached or attached) with open trusses can utilize this system. In a rental situation a landlord may allow for the tenant to use this as they could install, use and remove this system w/o ever leaving a mark or damage to the structure from fasteners and hardware.

In my own detached garage I had center storage above (at the high point), but there was no way to install a floor all around the outside perimeter, and that was a lot of wasted space. It was not possible for me to get around the low pitch to make a floor (plus the hazard of roofing nails poking down through the roof), and no way to store items around the outside perimeter.

So I came up with a way to utilize that area to store many things from below, and keep it simple.

The pictures will show the two different brackets which are made from a rigid material. I chose 16 gauge galvanized for the first ones shown here which are thin enough to slide down behind stapled wires. Each one will fall onto the 2″×4″ truss, aligning with the next truss to complete a row.

Moving down the truss from each one will be another bracket (on the same truss) spaced by choice to the distance desired. Next, you slide a rod of choice (aluminum, steel, pvc, wood etc.) through the aligned holes to become your crossbar then onto the next, and again with the opposing ones. You now have two crossbars to lay your skis or kayak etc. across, or plywood to place items upon. That is it, you just created storage space!

You can continue to add another panel between the next truss by only adding two more brackets and so on. A 10′ rod will give you 5 panels with trusses set on a common 24″center spacing. Use an optional coupler to join additional rod lengths if desired. One of the brackets shown has an extra slot for setting another rod into if desired, and is set lower than the weight bearing hole. So besides storing on the weight bearing rods, you now have a second lower rod for hanging items, wire hooks, or water supply water lines for barns, pets, and irrigation for green houses etc. Pneumatic compressor lines could also be set in there. You can add more brackets and rods for supporting longer lengths of board, as this is all adjustable and non-permanent. One ⅛″ pilot hole was provided if someone wants a set screw installed once everything is in place, but is not necessary or required. The included photos (if they download in order) will show the empty trusses first. Then brackets set on the trusses, rods installed, boards set on top, and the optional 3rd pipe/rod holding hanging items. No tools, hardware or fasteners were used, and it took very little time to setup the complete overhead storage system. Thank you for reading.

### BRIEF DESCRIPTION OF DRAWINGS

FIG. 1A.

A single truss storage hanging crossbar bracket laying on it's side showing a view of the round weight bearing hole on the right, and the optional slot on the left in which a second rod may be inserted in which to hang items from. Top center is a tiny pilot hole for a secure mount screw if desired.

FIG. 1B.

A single truss storage hanging crossbar bracket laying on it's side showing the weight bearing hole and the pilot hole.

FIG. 2A.

A view of a truss bracket on a piece of cardboard, upright on one end to show as many aspects of the item all at once. Here one can see how the shape was designed and intended to drop over a 2×4 truss beam and hang down while leaving the slot and hole below the bottom wood line in order to slide pipe or rod through to create the supporting crossbars.

FIG. 28.

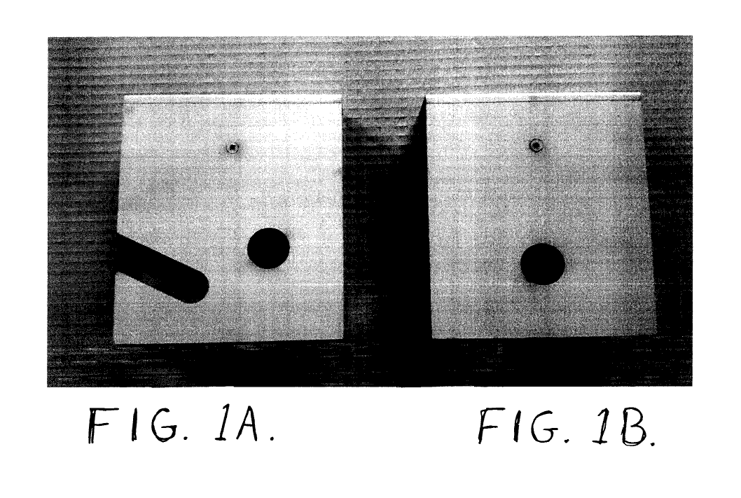

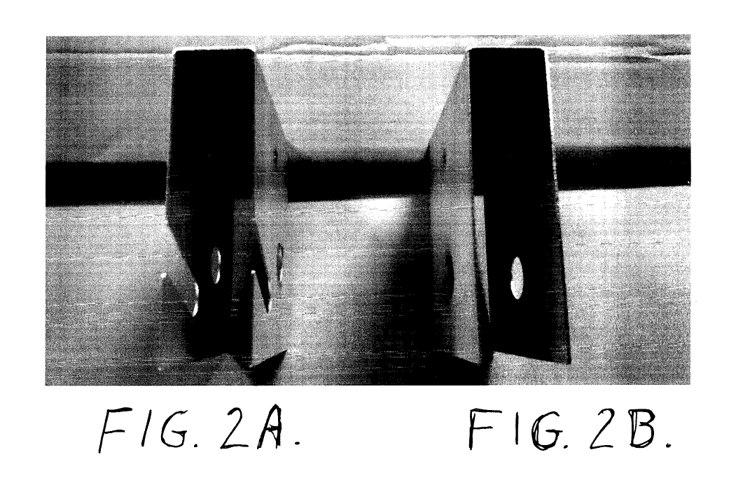

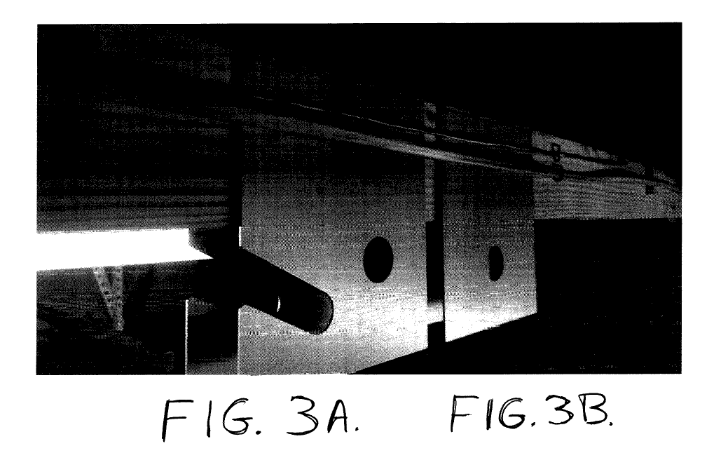

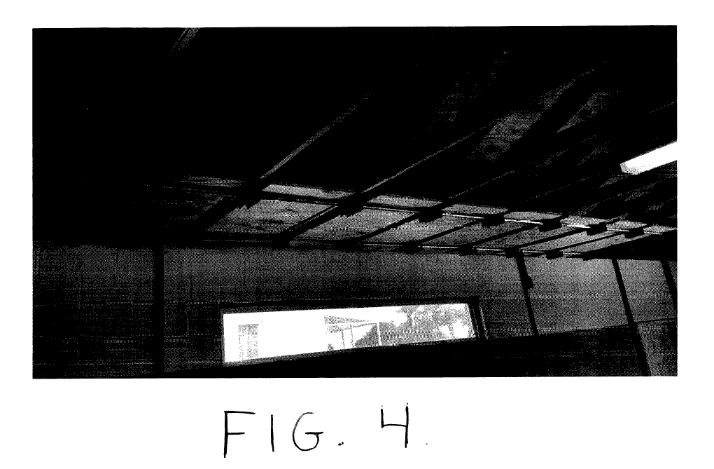

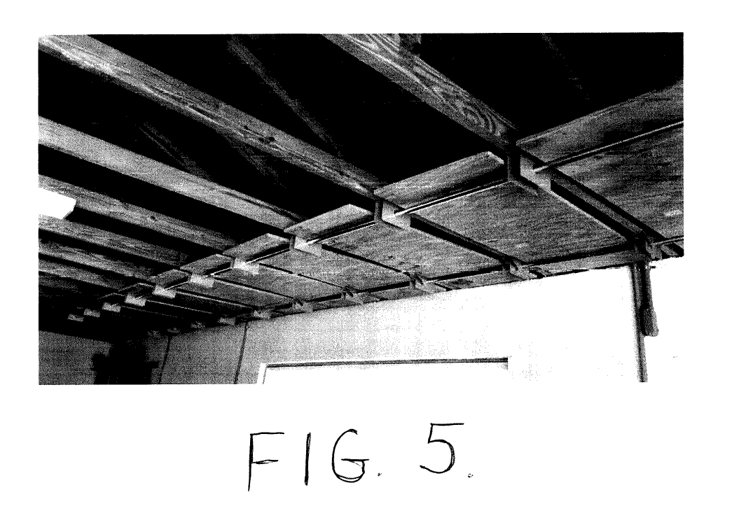

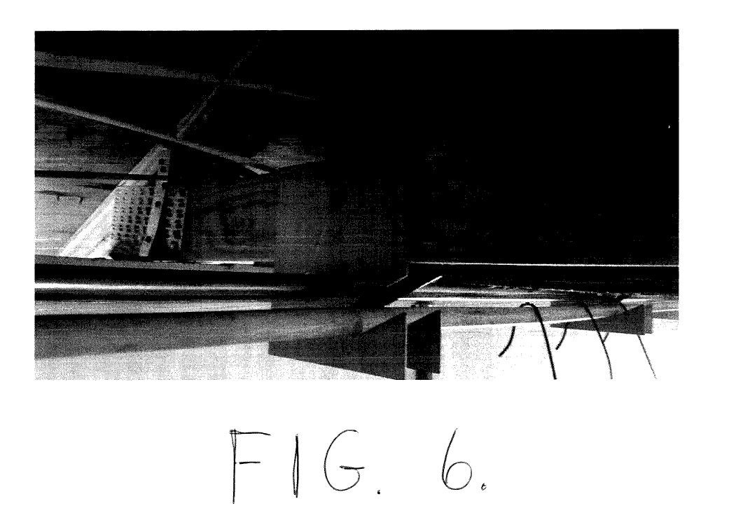

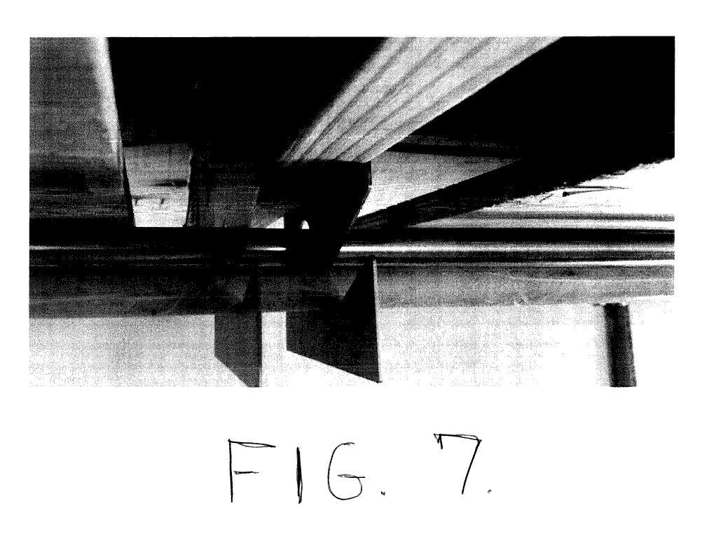

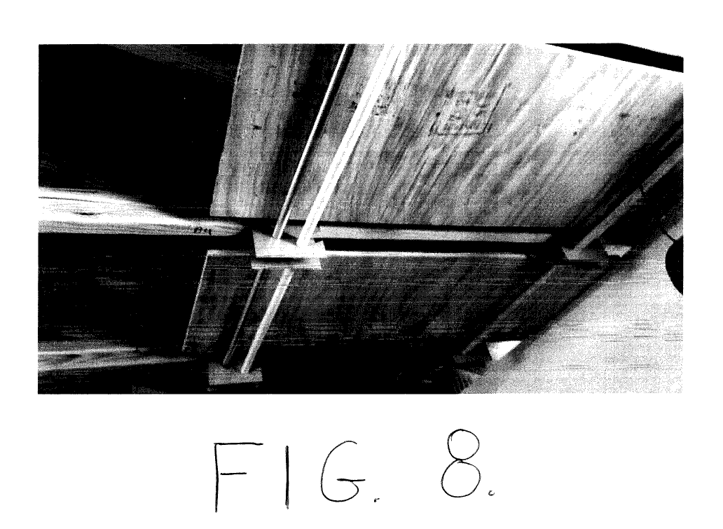

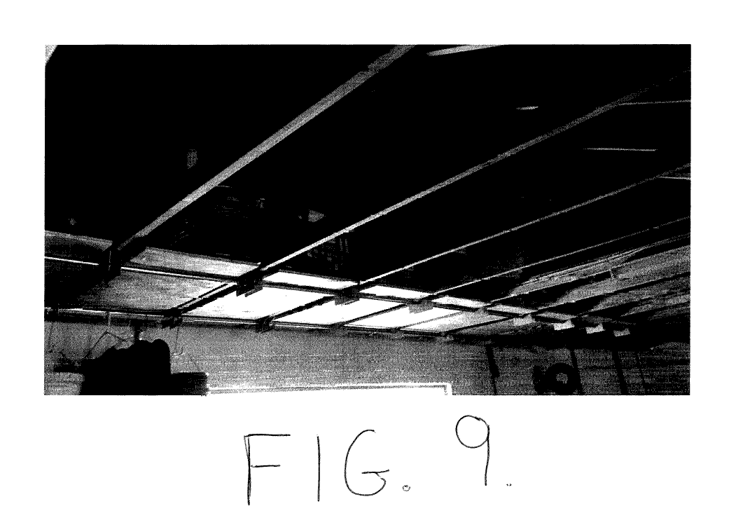

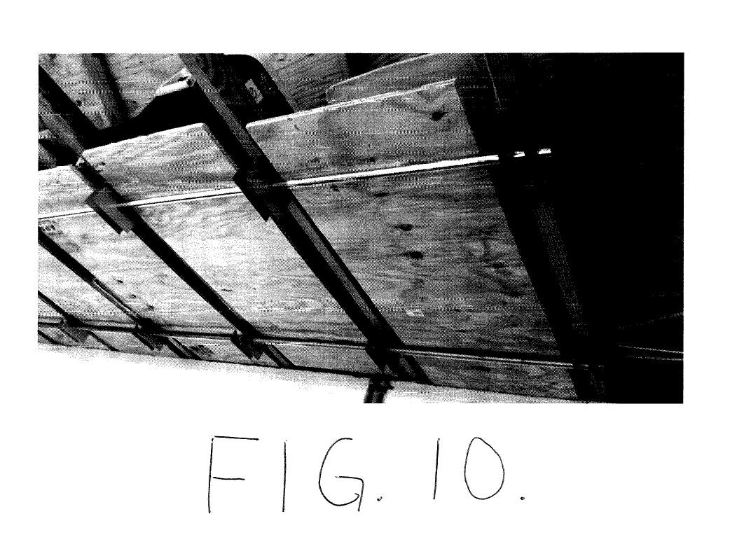

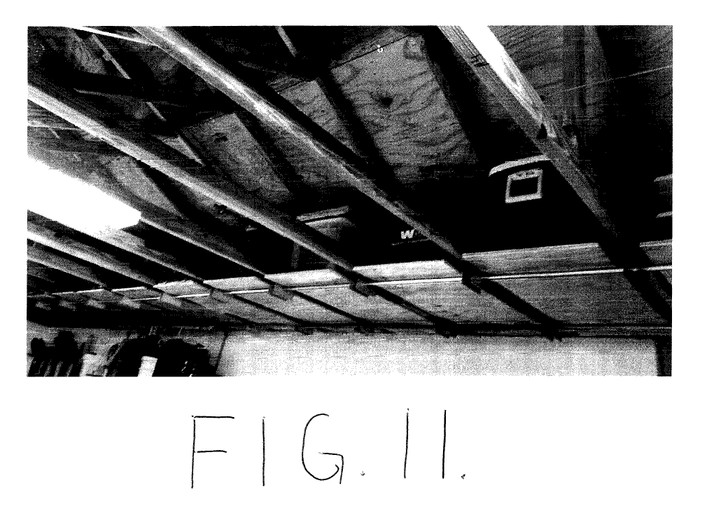

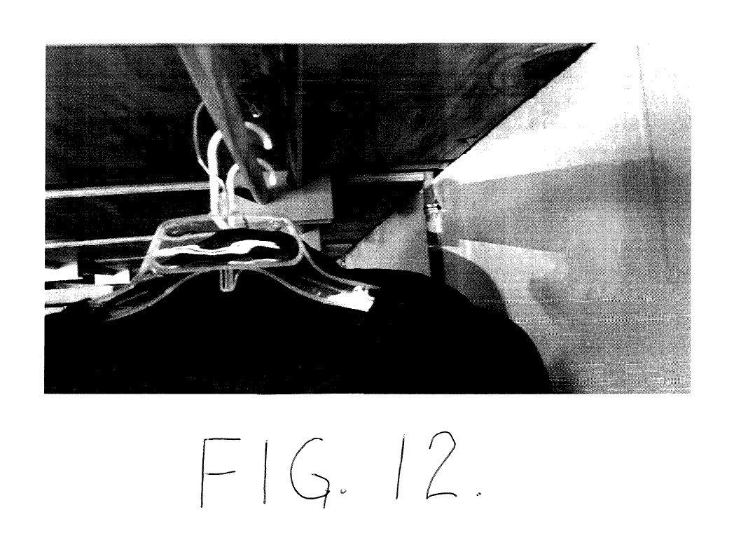

This is the same view and description as FIG. 2A. except the item marked 28 is the bracket without the optional secondary slot.

FIG. 3A.

This drawing is showing how this bracket is hanging down self supportive on a 2×4 truss beam without any hardware used to mount. The round hole accepts the weight bearing rod to slide through and the end of the angled slot is lower than the hole leaving a space for hooks etc. to hang on. The item also shows the thin design to fit behind most existing wiring.

FIG. 3B.

A crossbar bracket hanging on a 2×4 truss beam without the use of mounting hardware and leaving the weight bearing rod hole lower than the woodline in order to slide the support rod through.

FIG. 4.

This drawing is showing the truss storage hanging crossbar brackets installed on truss beams. They were set on there one at a time in a line and then a conduit supporting rod was slid through the round support holes. A second line of brackets were then set in a line, support rod slid through, creating two crossbars in which to set the pieces of plywood upon to create instant storage areas. This is all done from below so no need to have to climb up in and around beams.

FIG. 5.

The same description as FIG. 4 shown from a different angle illustrating the storage space created by simply dropping the brackets over the beams, sliding supporting rods through the holes and setting plywood upon the rods creating ready to use storage space.

FIG. 6.

A close up view of the bracket hanging on a truss beam without mounting hardware, supporting a piece of plywood with the upper round hole and the lower slot holding a rod used for hanging items and or hooks from.

FIG. 7.

Another close up view of the bracket hanging on a 2×4 lower truss beam with the support rod setting in the slot.

FIG. 8.

This figure is from ground level looking up at the brackets in use hanging without any use of hardware to install. The area that the trusses meet the wall is too low and small to access from above but this shows how the open end allows access from below in order to store items freely.

FIG. 9.

FIG. 9 is a view of the truss storage hanging crossbar brackets in use along with supporting rods, plywood and hooks creating instant storage space with hanging and stored above inventory items in this figure.

FIG. 10.

This figure is a view from below where the supporting rods can be seen going through the brackets holding the plywood that supports the items.

FIG. 11.

This is very similar to FIG. 9 as the brackets are seen along with rods and plywood creating a easy access storage shelf and rod for hanging items.

FIG. 12.

An upward view from along the wall with support rods holding plywood shelf and the second rod in the lower slot allowing for hooks, hangers etc.

1. No skill or experience needed.

2. (canceled)

3. No tools, fasteners or hardware required to install.

4. (canceled)

5. Does not damage the integrity of the truss structures.
